(19) United States
(12) Patent Application Publication
(10) Pub. No.: US 2005/0084023 A1
(43) Pub. Date: Apr. 21, 2005

(54) Method for the frequency and time synchronization of an odm receiver

(76) Inventors: Rainer Bott, Andechs (DE); Gunter Wicker, Munich (DE); Dimitri Korobkov, Frankfurt (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/472,070

(22) PCT Filed: Jan. 29, 2002
(86) PCT No.: PCT/EP02/00906

(30) Foreign Application Priority Data
Mar. 16, 2001 (DE) 101 12 773.1

(51) Int. Cl. H04K 1/10

(52) U.S. Cl. 375/260

(57) ABSTRACT

The invention relates to a frequency and time synchronization of a receiver (E) for receiving OFDM signals on a fixed carrier frequency. The inventive method is characterized by determining in a first step the approximate nominal value of the frequency and of the time origin of the OFDM signal via a two-dimensional frequency-time search mode and the determination of the area point with the optimum quality criterion of the OFDM signal or via the evaluation of a synchronization sequence transmitted by the transmitter. In a subsequent second step the phase of at least one of the pilot signals transmitted together with the OFDM signal is determined in the receiver (E) and is averaged across several OFDM signal blocks; and a more exact nominal value of the frequency and of the time origin of the OFDM signal is determined therefrom. The receiver (E) is then synchronized to the frequency so determined and the OFDM signal is demodulated with the time origin value so determined.

### BACKGROUND OF THE INVENTION

The invention relates to a method for frequency and time synchronization of a receiver used for receiving OFDM signals, which are sent on a fixed carrier frequency.

In modern digital technology, Orthogonal Frequency Division and Multiplexing (OFDM) systems are used for data transmission. According to this principle, before transmission, the digital data stream is converted by mapping into complex-value symbols and split into a large number of partial signals, each of which is transmitted on a separate carrier. The DVB-T (Digital Video Broadcasting) system, for example, uses 1,705 and/or 6,817 of these individual carriers. In the receiver, this partial information is combined to form the complete information from the transmitted digital-data stream. This OFDM system is already well known and has been described in greater detail, for example, by HERMANN ROHLING, THOMAS MAY, KARSTEN BRÜNINGHAUS and RAINER GRÜNHEID, Broad-Band OFDM Radio Transmission for Multimedia Applications, Proceedings of the IEEE, Volume 87, No 10, October 1999, page 1778 ff.

With systems of this kind, it is important that the receiver is accurately synchronized, with reference to frequency and time, to the OFDM signal blocks transmitted. Doppler and frequency shifts of the individual carriers can occur as a result of movement of the transmitter and/or receiver and/or as a result of differences in frequency. Moreover, it is important that the receiver is also accurately synchronized with reference to time to the origin of the orthogonality interval of the OFDM signal blocks. As a result of differences in propagation delay, depending, for example, on the distance between the transmitter and the receiver, the OFDM signal blocks do not always reach the receiver at the same nominal time.

The object of the present invention is to provide a method with which an OFDM receiver of this kind can be synchronized to the received OFDM signal with reference to frequency and time as rapidly and accurately as possible.

### SUMMARY OF THE INVENTION

According to the invention, two successive procedural steps allow rapid frequency and time synchronization of a OFDM receiver. The computational effort required in this context is limited as a consequence of receiving on a fixed carrier frequency, because the fixed frequency mode allows the use of special averaging and smoothing methods.

### BRIEF DESCRIPTION OF SEVERAL VIEWS OF THE DRAWINGS

The invention is described below with reference to schematic drawings and exemplary embodiments.

FIG. 1 shows block circuit diagrams for a high frequency receiver used for receiving OFDM signals, which are received on a fixed carrier frequency by a receiver component (E). Frequency and time synchronization in this exemplary embodiment is carried out according to the first alternative for the first procedural step, namely with a two-dimensional frequency-time search mode. After the analogue high-frequency receiver component E, the received OFDM signal is digitised in an analogue/digital converter A/D and stored in a buffer memory S. A two-dimensional frequency and time search device Z is provided for synchronization, by means of which, during a two-dimensional search phase, a frequency-dependent quality criterion of the received OFDM block is determined for each sample of the A/D converter within a predefined frequency range f₁ to f₂, in which the nominal frequency value f₀ of the receiver is disposed. The two-dimensional search is shown in schematic form in FIG. 2. Between f₁ and f₂, the frequency search range forms one dimension of the two-dimensional search range; the other dimension forms a time search range between τ₁ and τ₂ with the nominal time origin τ₀ of the OFDM block. A quality criterion for the received OFDM block is determined for every point in this two-dimensional frequency-time search range f₁ to f₂ and/or τ₁ to τ₂. The step size at which the frequency range f₁ to f₂ is searched, depends upon the type of OFDM signal and the maximum anticipated difference between the nominal frequency position f₀ and the actual frequency position fₓ. The step size on the time axis is determined by the sampling rate of the A/D converter; the step size can be a multiple of a sample. In FIG. 2, the total search range is indicated by cross-hatching.

### DETAILED DESCRIPTION OF THE INVENTION

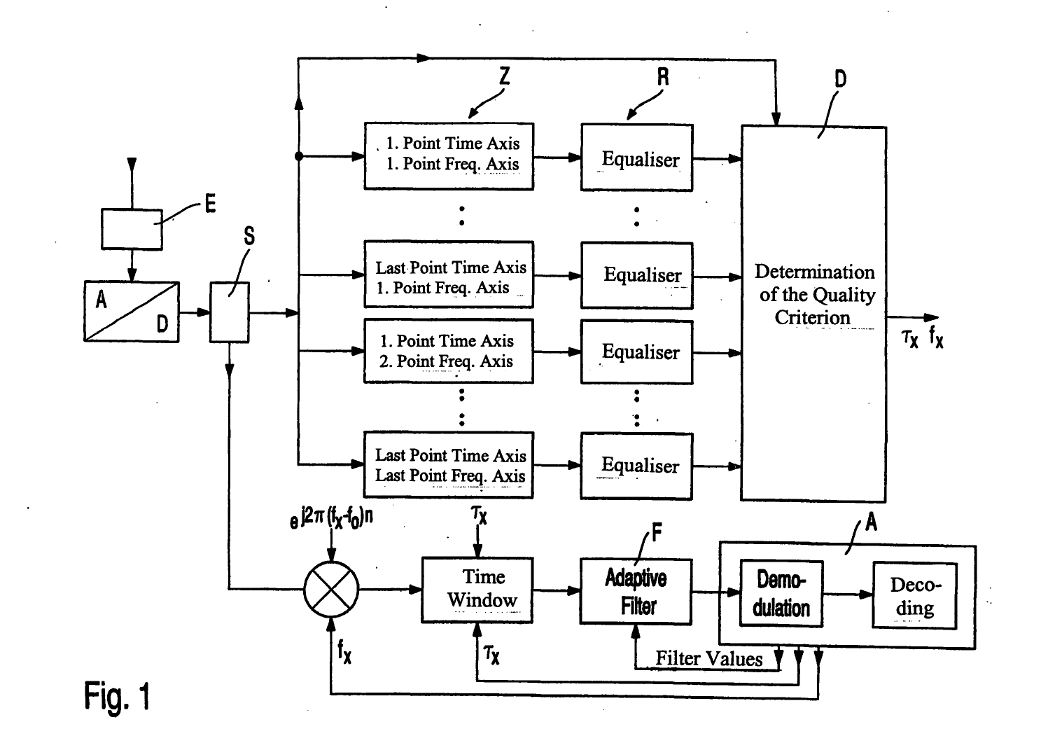

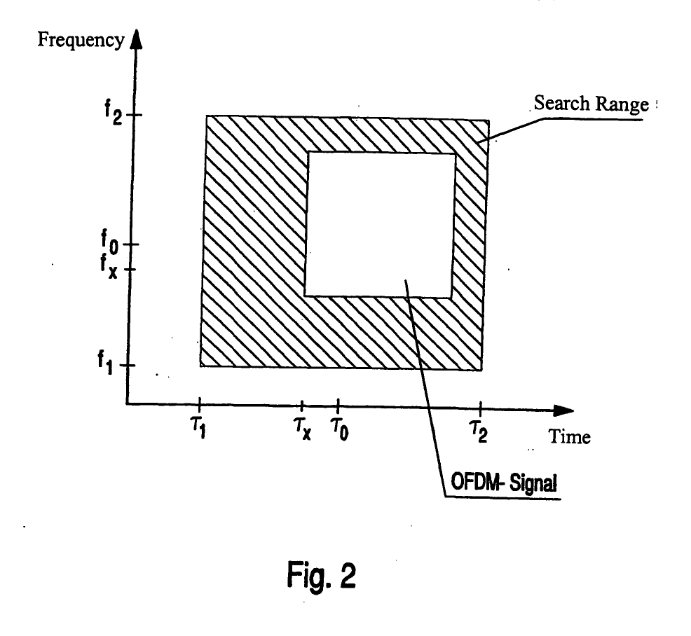

In the transmission channel, the OFDM signal, received and stored in the buffer memory S in at least two successive OFDM blocks, is distorted to a greater or lesser extent. These distortions can have an influence on the two-dimensional search, that is to say, as a result of distortions of this kind, the optimum for the quality criterion can be displaced. It is therefore advantageous to equalize the signal before evaluating the two-dimensional search and determining the quality criterion. For this purpose, equalizers R are provided in each case, as shown in FIG. 1; these are connected downstream of the computer unit D used for determining the quality criterion. In this context, one possibility for equalization is to evaluate the pilot carriers transmitted together with the OFDM signal. These signals are generally used to synchronize the phase thereby allowing coherent demodulation, but in the present case, they can additionally be used for equalization. Because of the known the known amplitudes and phase positions of these pilot carriers relative to one another, the channel distortion can be determined in a known manner. The equalizers R therefore contain information about the phase and amplitude response of the transmission channel between the transmitter and the receiver at the predetermined fixed transmission frequency, and can therefore equalize the OFDM signal appropriately. This may occur, for example, in that each OFDM carrier is multiplied by a complex value, which corresponds to the amplitude and phase response of the transmission channel. If the OFDM carriers are only modulated by means of phase and frequency modulation, it may be sufficient, under some circumstances, to multiply by a phase value, which is obtained as the result from the estimation of the phase response of the transmission channel. However, if the carrier is amplitude-modulated, it is necessary to multiply by the inverse of the estimated amplitude response (division). In the case of combined amplitude and phase modulation, as used, for example, for high-order QAM modulation, the relevant carrier must be divided by the complex, estimated value for the transmission function of the transmission channel.

The quality criterion for the OFDM signal is determined in the computer D for each point during the two-dimensional search operation by comparing the input signal (output signal from the buffer memory S) with the output signal from the equalizer R; that is to say, the distance by which the momentary frequency value differs from the nominal target value is calculated. In general, the criterion is the Euclidian distance, but it may also be the absolute value for the distance or the value for the phase difference of the individual carriers. For every area point of the two-dimensional search range, the area point with the optimum quality criterion is determined from the quality criteria for frequency and time determined in this manner, and the receiver can therefore be roughly synchronized in a first procedural step taking into consideration the difference between the nominal frequency and the frequency value which corresponds to the optimum quality criterion. Starting with the time value which corresponds to the optimum quality criterion, the OFDM signal can then be demodulated and, optionally, also decoded. However, since the actual values for frequency and time in this first procedural step are reached only approximately, the actual, accurate frequency and time synchronization, which uses continuing evaluation criteria, is implemented in a second procedural step following this.

In the second and subsequent procedural step, the phase positions of the pilot carriers, which are transmitted and received together with the OFDM signal blocks, are evaluated. In the demodulator, the phases of the simultaneously transmitted pilot carriers are calculated for every OFDM signal block. Following this, the phases of the individual pilot carriers are averaged appropriately across several successive OFDM blocks; that is to say, they are filtered and smoothed. In a first stage, the phases of the pilot carriers determined in one OFDM block are unwrapped (Unwrapping represents a mapping of the phases, which have been calculated using the arc-tangent on the interval −π to +π, onto the continuous phase axis. This takes into account the fact that the phase between OFDM blocks does not change abruptly). Each of the phases projected in this manner can then be filtered to increase measuring accuracy by means of a narrow-band filter. Suitable filters include linear regressions, so-called ‘order statistic filters’ such as median filters or PLL structures.

The determined phase characteristics of the individual pilot carriers are functions of the frequency offset occurring as a result of the oscillator offset between transmitter and receiver, and as a result of Doppler shifts, caused by the movement of the transmitter and/or receiver, or as a result of a misalignment of the sampling clock between the transmitter and receiver and the relative position of the pilot carrier within the OFDM block. Accordingly, the frequency offset and also the clock misalignment can be calculated from these phase characteristics. In this manner, in the second procedural step, the nominal frequency and the time of origin of the OFDM blocks can be determined with considerably greater accuracy by averaging the phases of the pilot carriers across several OFDM blocks. The receiver is then finally synchronized with these values and also continuously-adjusted throughout transmission; that is to say, during the transmission, only this second procedural step is performed using the phase position of the pilot carriers for synchronization.

To ensure that isolated strong deviations are ignored as much as possible in the averaging of the phase values, the filtered phase values are weighted in dependence upon a quality criterion; that is to say, values deviating strongly from the other values are taken into consideration less in the averaging procedure. This quality criterion is linked in a multiplicative manner to the relevant optimum values and it is used either to exclude the value from the averaging altogether or to give it a reduced significance. This criterion is preferably derived from the quality of the decoding of the OFDM receiver. A Maximum-Likelihood-Decoder (ML), which additionally provides a quality criterion as a result from the decoding process, is often supplied with OFDM receivers of this kind. This criterion can be used directly in the averaging for weighting the filter values. APP-decoders are also suitable for this purpose, because they also provide an appropriate quality criterion for the received OFDM signals; in this case, this is referred to as the aposteriori-probability. The results from a CRC-decoding can also be used as a quality measure in this context.

Before the actual demodulation and decoding in the OFDM receiver A, the received signals are filtered in an adaptive digital filter F. This adaptive filter is controlled with reference to its filter values via a demodulator in the receiver A. The frequency and time values calculated in the receiver are also supplied to this filter.

During transmission, the determined optimum sampling point and the actual frequency change only slowly or do not change at all. A slow change is possible, for example, if the transmitter and receiver are moving away from one another or approaching one another. Because of the slowness of the changes, these values can be adjusted. In this context, the determined optimum frequency and time values in the OFDM receiver A are adjusted via an adaptive filter. A Kalman filter is particularly suitable in this context.

With fixed-frequency operation of the receiver, the adaptive input filter F can also be updated by means of Decision Feedback (DFE), in that the OFDM signal is demodulated and decoded after the exact frequency and time values have been determined, and a further channel estimation and equalization is then implemented using this decoded OFDM signal. The adaptive input filter F is then adjusted via this DFE.

The clock phases may drift because of differences between the oscillators in the transmitter and receiver. As a result, without additional measures, one sample too many or too few may occasionally be produced in the receiver. This can be compensated either by adjusting the sampling clock in the receiver, for example, by controlling the clock for the A/D converter or the main oscillator, from which the individual clocks are derived. Another possibility is to adjust the difference in the equalization filter by phase displacement until the threshold is exceeded by one sample. Having been displaced by one sample forwards or backwards, the signal can simply be used at this threshold.

In the first procedural step for roughly determining the frequency and the origin of the OFDM signal, the evaluation of a synchronization sequence, either transmitted by the transmitter at the beginning of the transmission and/or repeated cyclically or acyclically, can be used instead of the two-dimensional search procedure described above. This further simplifies the synchronization procedure. Any known signal, by means of which the approximate nominal frequency and the nominal time origin of the OFDM signal can be determined directly in the receiver, may be used as a synchronization sequence, for example, a chirp signal. The adaptive input filter F is controlled accordingly with these values, once again, as shown in FIG. 1. The length of the impulse response of the entire transmission function (channel+receiver filter) must not exceed the length of the OFDM protection interval. The filter is preferably produced in such a manner that an optimum Wiener filter is produced. In this case also, the adaptive input filter can be adapted to changing propagation conditions by DFE. The second, subsequent procedural step is again performed as described above.

1. A method for frequency and time synchronization of a receiver for receiving an OFDM signal on a fixed carrier frequency, said method comprising:
a first step, wherein approximate nominal values for a frequency and a time origin of an OFDM block are determined via: (a) a two-dimensional frequency-time search mode and by determining an area point with an optimum quality criterion of the OFDM signal, or (b) evaluating a synchronization sequence transmitted by a transmitter; and
in a second, step subsequent to the first step, wherein more exact nominal values for the frequency and time origin of the OFDM block are determined,
wherein the receiver is then synchronized to the frequency determined thereby, and the OFDM signal is demodulated starting with the time-origin value determined thereby, and wherein in the second step in the receiver, a phase of at least one pilot carriers transmitted together with the OFDM signal is determined and averaged across a plurality of OFDM signal blocks and the more exact nominal value for the frequency and time origin of the OFDM block is determined with reference thereto

2. The method according to claim 1, wherein during a transmission time following an initial frequency and time synchronization, only the second step is repeated either continuously periodically or aperiodically.

3. The method according to claim 1, wherein an adaptive digital filter, which is controlled via filter constants calculated in the receiver, is disposed at an input of the OFDM receiver.

4. The method according to claim 3, wherein the adaptive filter is additionally adapted to changing propagation conditions of a transmission channel.

5. The method according to claim 4, wherein: (i) in the first step, a quality criterion of the OFDM signal is determined for every point of a two-dimensional frequency-time search range, which is determined in one dimension by a frequency search range including the nominal frequency of the OFDM signal, and in a second dimension by a time-search range including the nominal origin of the OFDM signal; (ii) the area point with the optimum quality criterion of the OFDM signal is then determined-with reference thereto (iii) finally, the receiver is synchronized to the nominal frequency, taking into consideration the difference between the nominal frequency and the frequency value corresponding to the optimum quality criterion; and (iv) the OFDM signal is demodulated starting with a time value corresponding to the optimum quality criterion.

6. (canceled).

7. The method according to claim 5, wherein a deviation (distance) between the input and an output of an equalizer is used as the quality criterion.

8. (canceled).

9. The method according to claim 7, wherein, either at the start of a transmission or periodically and/or aperiodically during the transmission, a synchronization sequence in a form of a special bit pattern is transmitted by the transmitter, and the optimum quality criterion is determined with reference thereto.

10. The method according to claim 9, wherein equalization is carried out by multiplication of the individual OFDM carriers with a complex value corresponding to an amplitude and phase response of the transmission channel.

11. The method according to claim 10, wherein the averaging of the phase values of the pilot carriers calculated in the second step is carried out by filtering and smoothing across a plurality of OFDM signal blocks.

12. The method according to claim 11, wherein a linear regression is used for filtering.

13. The method according to claim 11, wherein an order statistic filter is used for filtering.

14. The method according to claim 11, wherein a phase-control loop is used for filtering.

15. The method according to claim 14, wherein the calculated phase values are weighted in dependence upon a quality criterion of the OFDM signals and taken into account in the averaging in an appropriately weighted manner.

16. The method according to claim 15, wherein, the quality of the decoding result in the receiver is used as the weighting criterion.

17. The method according to claim 16, wherein an additional adaptive filter, by means of which slow changes can be compensated, is provided in the receiver demodulator.

18. The method according to claim 17, wherein after determining the more exact values for frequency and origin of the OFDM signals, the OFDM signals are demodulated, decoded, and then used to perform a further channel estimation and equalization of the OFDM signal.

19. The method according to claim 18, wherein the sampling clock in the receiver is synchronized with the transmitter sampling clock either by controlling the main oscillator or the sampling clock of the A/D-converter, or by phase displacement in the receiver filter.

20. The method of claim 1, wherein during the first step, the quality criterion is also determined for pilot carriers transmitted together with the OFDM signals.

21. The method of claim 1, wherein in the first step, before the determination of the optimum quality criterion, the transmission function of the transmission channel is estimated for every carrier of the OFDM signal, using pilot carriers transmitted in the OFDM signal, and the OFDM signal is equalized in dependence thereon.
